(19) United States
(12) Patent Application Publication
(10) Pub. No.: US 2026/0288834 A1
(43) Pub. Date: Sep. 24, 2026

(54) SYSTEM AND COMPUTER-IMPLEMENTED METHOD FOR CONVERTING A HUMAN INTENT OF A USER INTO AN ARTIFICIAL INTELLIGENCE PROMPT

(71) Applicant: The Mirror Project LLC, Boca Raton, FL (US)

(72) Inventor: Scott Lipskin, Boca Raton, FL (US)

(73) Assignee: The Mirror Project LLC, Boca Raton, FL (US)

(21) Appl. No.: 19/687,909

(22) Filed: May 26, 2026

Related U.S. Application Data
(63) Continuation-in-part of application No. 19/425,024, filed on Dec. 18, 2025.

(51) Int. Cl. G06F 16/334; G06F 16/335

(52) U.S. Cl. CPC G06F 16/3344; G06F 16/337

(57) ABSTRACT

A system is provided for converting a human intent of a user into an artificial intelligence (AI) prompt. The system includes one or more processors and a memory storing instructions that, when executed by the one or more processors, cause the system to implement a user input device, an interpretation generation engine, a user selection module, a prompt formulation engine, and an AI engine interface. The user input device receives a textual statement from the user, wherein the textual statement includes unstructured natural language expressing the human intent. The interpretation generation engine receives the textual statement, parses the textual statement to extract semantic features, analyzes the textual statement, and generates semantic interpretations. The user selection module receives a selection of a first semantic interpretation. The prompt formulation engine generates the AI prompt. The AI engine interface sends the AI prompt to the AI model.

### CROSS-REFERENCE TO RELATED APPLICATION

This application is a continuation-in-part patent application which claims priority to and claims the benefit of U.S. patent application Ser. No. 19/425,024, filed Dec. 18, 2025, the contents of which are incorporated herein by reference in their entirety.

### BACKGROUND OF THE INVENTION

Artificial Intelligence (AI) is becoming more and more integrated into society as time goes on. However, interacting with AI presents challenges for people, particularly elderly people who do not know how to “talk” to AI systems in the way that produces consistently accurate, useful responses. Common issues include that they phrase prompts vaguely or emotionally (e.g., “This thing is broken, what do I do?”). Poor prompts lead to bad answers or hallucinations, which often leads users to blame the AI. This is a universal friction point across consumer and enterprise AI tools.

It is with respect to these and other considerations that the instant disclosure is concerned.

### SUMMARY

In one example, a system is provided for converting a human intent of a user into an artificial intelligence (AI) prompt. The system comprises one or more processors; and a memory storing instructions that, when executed by the one or more processors, cause the system to implement: a user input device configured to receive a textual statement from the user, the textual statement comprising unstructured natural language expressing the human intent; an interpretation generation engine configured to: receive the textual statement, parse the textual statement to extract semantic features from the unstructured natural language, analyze the textual statement by mapping the semantic features against stored semantic data, and generate a plurality of distinct semantic interpretations of the textual statement based on the analysis, wherein each semantic interpretation resolves one or more dimensions of ambiguity in the textual statement and has an associated hidden machine-optimized prompt representation that is not exposed to the user; a user selection module configured to receive, from the user via the user input device, a selection of a first semantic interpretation of the plurality of semantic interpretations, the first semantic interpretation comprising a clarified human intent explicitly confirmed by the user; a prompt formulation engine configured to generate the AI prompt based at least in part on the selected first semantic interpretation and its associated machine-optimized prompt representation such that the AI prompt is structured to elicit an improved response from an AI model; and an AI engine interface configured to send the AI prompt to the AI model.

In another aspect, a computer-implemented method is provided for converting a human intent of a user into an artificial intelligence (AI) prompt. The method comprises receiving, by a user input device, a textual statement from the user, the textual statement comprising unstructured natural language expressing the human intent; by an interpretation generation engine: receiving the textual statement, parsing the textual statement to extract semantic features from the unstructured natural language, analyzing the textual statement by mapping the semantic features against stored semantic data, and generating a plurality of distinct semantic interpretations of the textual statement based on the analysis, wherein each semantic interpretation resolves one or more dimensions of ambiguity in the textual statement and has an associated hidden machine-optimized prompt representation that is not exposed to the user; receiving, by a user selection module from the user via the user input device, a selection of a first semantic interpretation of the plurality of semantic interpretations, the first semantic interpretation comprising a clarified human intent explicitly confirmed by the user; generating, by a prompt formulation engine, the AI prompt based at least in part on the selected first semantic interpretation and its associated hidden machine-optimized prompt representation such that the AI prompt is structured to elicit an improved response from an AI model; and sending, by an AI engine interface, the AI prompt to the AI model.

Additional embodiments, features, and advantages of the disclosed system and method are described in the detailed description below. It is to be understood that both the foregoing general description and the following detailed description are exemplary and explanatory and are intended to provide further explanation of the invention as claimed.

### BRIEF DESCRIPTION OF DRAWINGS

FIG. 1 shows a simplified view of a system for converting a human intent of a user into an artificial intelligence (AI) prompt, in accordance with one non-limiting embodiment of the disclosed concept.

FIG. 2A shows a user input device displaying an AI engine interface, and being configured for selective activation of an interpretation generation engine of the system of FIG. 1.

FIG. 2B shows the user input device of FIG. 2A displaying a textual statement of the user.

FIG. 2C shows the user input device of FIG. 2B displaying a plurality of semantic interpretations of the textual statement.

FIG. 2D shows the user input device of FIG. 2C displaying an AI prompt that has been generated.

FIG. 2E shows the user input device of FIG. 2D displaying a response by an AI model.

FIG. 3A shows the user input device of FIG. 2A being configured to receive another textual statement from the user.

FIG. 3B shows the user input device of FIG. 3A displaying a plurality of semantic interpretations of the textual statement of FIG. 3A, and which include at least one of the semantic interpretations of FIG. 2C.

FIG. 4 shows an example method for converting a human intent of a user into an AI prompt, and shows optional method steps in dashed line drawing.

FIG. 5 shows a simplified view of an internal architecture for an interpretation generation engine of the system of FIG. 1.

FIG. 6 show a simplified view of a control mechanism for the system of FIG. 1.

FIG. 7 shows a simplified view of an optional feedback loop for the system of FIG. 1.

FIG. 8 is a hybrid architecture of an interpretation generation engine of the system of FIG. 1.

### DETAILED DESCRIPTION OF THE INVENTION

In the following description, for the purposes of explanation, numerous specific details are set forth in order to provide a thorough understanding of various embodiments of the invention. As used herein, “embodiments” are non-limiting examples of apparatuses or methods employing one or more of the inventive concepts disclosed herein. It is apparent, however, that various embodiments may be practiced without these specific details or with one or more equivalent arrangements. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features of the various embodiments may be otherwise combined, separated, interchanged, and/or rearranged without departing from the inventive concepts.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “may include,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, may be used as terms of approximation and not as terms of degree, and, as such, are utilized to account for inherent deviations in measured, calculated, and/or provided values that would be recognized by one of ordinary skill in the art.

As employed herein, the term “number” shall mean one or an integer greater than one (i.e., a plurality).

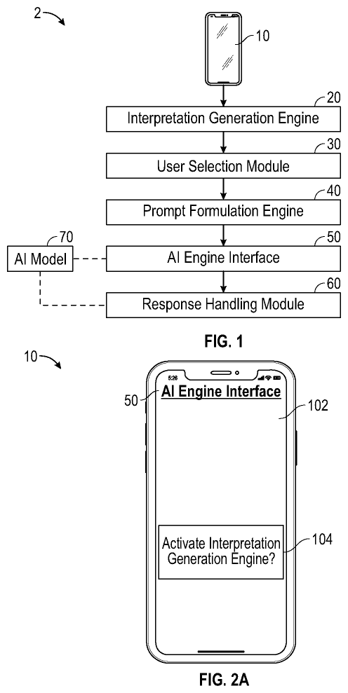

FIG. 1 shows a system 2 for converting a human intent of a user into an artificial intelligence (AI) prompt, in accordance with one non-limiting embodiment of the disclosed concept. In one example, the system 2 translates natural-language user intent into optimized AI prompts via a guided, multi-option intent clarification interface. In plain terms, the user types what they want to know in their own words, and the system 2 then generates a plurality of refined semantic interpretations of that request. In one example, each interpretation may be framed as a specific, structured query style directive (e.g., without limitations, step-by-step instructions, explanation, fastest workaround, preparation checklist, etc.). The user may then simply select the option that best matches what they actually want, and based at least in part on that selection, the system 2 may generate a high-precision AI prompt that uses the correct trigger words, structure, and/or context to elicit the best possible response from the underlying AI model. Subsequently, that optimized prompt may then be sent to the AI model. Additionally, during operation of the system 2, the user may only see a clean interface of a user input device, and not internal machine-friendly formulations that are generated for the semantic interpretations.

The system 2 thus functions as an intent-translation layer between the human user and the AI model in order to make interaction with AI much simpler for elderly people and others who are not as able to generate machine-friendly AI prompts. As a result, the system 2 makes resulting AI responses more accurate because AI prompts in the system 2 are based not on human intent, but instead are based on clarified human intent. Right now, most AI interfaces (not shown) assume users will either learn prompting or will accept mediocre answers. There is no standardized, system-level translation layer that converts messy human intent into well-formed prompts. The system 2 solves these issues in the art.

In one example, the system 2 includes a user input device 10, an interpretation generation engine 20, a user selection module 30, a prompt formulation engine 40, an AI engine interface 50, and a response handling module 60. In the example of FIG. 1, the system 2 may be configured to interact with an AI model 70, which may be any AI model. More specifically, the system 2 may be model-agnostic, such that it can sit on top of any model or provider (e.g., OpenAI, Google, etc.), and act as a universal human-to-AI translation layer.

The user input device 10 is depicted as being a mobile device 10, but it will be appreciated that any other user device may be employed by the system 2 in place of the mobile device, including, for example and without limitation, tablets, computers, mobile watches, and the like. The interpretation generation engine 20 may include at least one of a number of rules, a number of templates, a number of probabilistic models, and at least one machine-learning model. In one example, the interpretation generation engine 20 may operate by mapping user input against stored semantic patterns, intent templates, prior user selections, confidence thresholds, and/or probabilistic scoring models to generate distinct candidate interpretations.

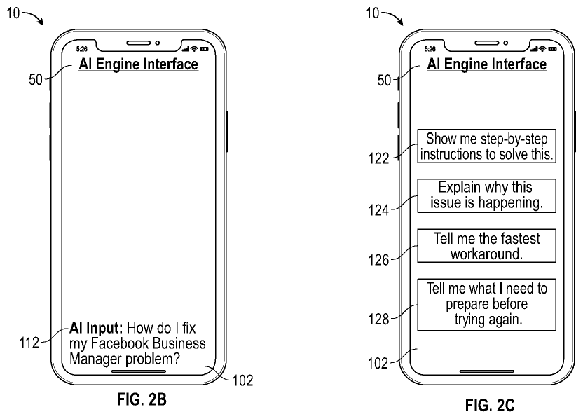

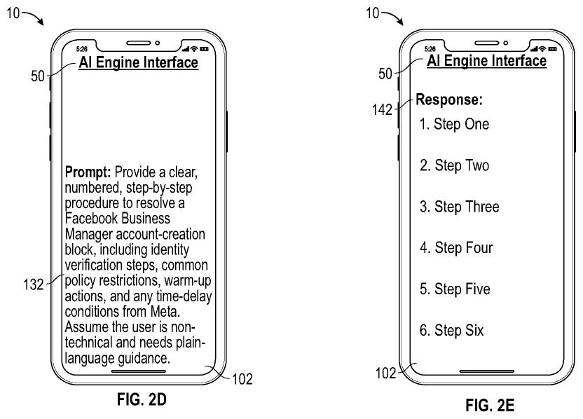

FIG. 2A shows the user input device 10 having a display screen 102 displaying the AI engine interface 50 to a user. In accordance with the disclosed concept, it will be appreciated that the system 2 may be either automatically configured to operate via the user input device 10, or may be selectively activatable such that a user selection governs downstream behavior of the system 2. In the example of FIG. 2A, responsive to the user selecting a button 104, the interpretation generation engine 20 may be selectively activated, and the AI engine interface 50 may be configured to receive a textual statement from the user.

Accordingly, the system 2 may be invoked as an optional “Prompt Mode.” In practice, this means the user can toggle Prompt Mode (e.g., the button 104) on or off as needed. When activated, the system 2 translates natural-language intent into optimized AI instructions and/or trigger structures. When deactivated, the user interacts with the system 2 normally (e.g., typed or spoken input without translation). The disclosed optional-mode architecture may be intentional. Specifically, users may not always want or need mediation, such that a “Prompt Mode” may be invoked only when clarity, precision, and/or outcome-optimization may be desired. The system 2 thus supports selective activation, user-controlled invocation, compatibility with both typed and spoken input, and integration as a built-in or layered operator mode rather than a mandatory interface.

FIG. 2B illustrates the display screen 102 after the user has selected the button 104, or without a selection of the button 104 in the instance when the interpretation generation engine 20 is automatically activated. As shown, the user input device 10 may be configured to receive a textual statement 112 from a user that has human intent. In one example, the textual statement 112 may be a typed textual statement and may be a spoken textual statement. It will be appreciated that the textual statement 112 may not be configured to elicit an accurate response from the AI model 70. That is, the textual statement 112 on its own may be more likely than not to elicit a hallucinatory response from the AI model 70. The system 2 thus provides a remedy.

More specifically and with reference to FIG. 2C, responsive to the system 2 receiving the textual statement 112, the interpretation generation engine 20 may be configured to receive the textual statement 112 and generate a plurality of semantic interpretations 122,124,126,128 of the textual statement 112. In one example, each of the semantic interpretations 122,124,126,128 may be framed as a structured query style directive.

As shown in FIG. 2C, each of the semantic interpretations 122,124,126,128 may have different clarified human intent of the textual statement 112, thereby resolving ambiguity in meaning, scope, constraints or objective. As will be discussed, any one of the semantic interpretations 122,124,126,128 may allow the user to actively generate a more accurate AI response than if the textual statement 112 were directly introduced into the AI model 70. Such a resulting AI response may be more aligned with what the user actually wanted when the textual statement 112 was first typed or spoken. It will also be appreciated that the user selection module 30 may be configured to receive a selection from the user of any one of the semantic interpretations 122,124,126,128. In the example of FIGS. 2A-2E, the first semantic interpretation 122 has been selected by the user.

FIG. 2D shows the user input device 10 displaying an AI prompt 132 that has been generated by the system 2 responsive to the selection of the user of the first semantic interpretation 122. In one example, the prompt formulation engine 40 may be configured to generate the AI prompt 132 based at least in part on the selection such that the AI prompt 132 is configured to elicit a response from the AI model 70 based on the clarified human intent of the first semantic interpretation 122. It will be appreciated that the AI prompt 132 may include trigger words specifically designed to improve AI accuracy and reduce hallucinations. Moreover, generation of the AI prompt 132 may be further based on the textual statement 112 in addition to the selection of the first semantic interpretation 122.

Accordingly, by basing the AI prompt 132 at least in part on the first semantic interpretation 122, the AI prompt 132 is much better configured to elicit a response from the AI model 70 that does not contain significant amounts of hallucinatory content. In other words, the system 2 therefore generates more accurate responses. For an elderly person who may be uncomfortable with prompting, this translates into a much better AI experience in which new skills do not have to be learned.

FIG. 2E shows the user input device 10 displaying a response 142 that was generated by the AI model 70 responsive to receiving the AI prompt 132. In one example, the AI engine interface 50 may be configured to send the AI prompt 132 to the AI model 70, and the response handling module 60 may be configured to generate the response 142. The system 2 thus provides a bridge for elderly people and others who cannot easily write or say AI prompts which elicit non-hallucinatory AI responses. In other words, the system 2 makes the AI model 70 significantly easier to communicate with.

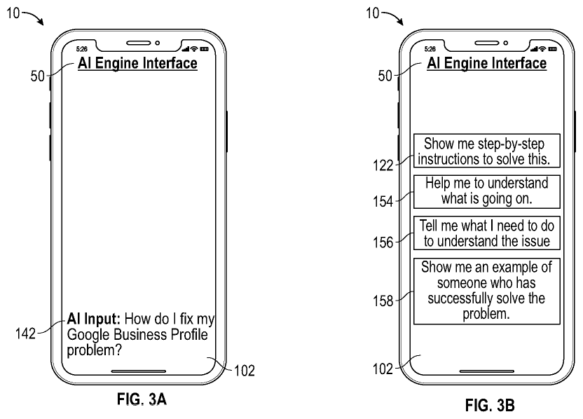

It will also be appreciated that the system 2 may be configured to save and utilize selections of the semantic interpretations 122,124,126,128. For instance, in the case of FIGS. 2A-2E, the selection of the first semantic interpretation 122 may be stored by the system 2 in a storage (e.g., memory, cloud storage, and the like). Subsequently, when the user interacts with AI engine interface 50 a second time, third time, etc., this initial selection is remembered and utilized. FIGS. 3A and 3B illustrate this example.

In the example of FIG. 3A, the user input device 10 is shown displaying another textual statement 142 on the display screen 102. In one example, the textual statement 142 has a request signature that matches a request signature of the textual statement 112. Thus, as shown in FIG. 3B, when the textual statement 142 is sent by the user, the interpretation generation engine 20 may generate a second plurality of semantic interpretations 122,154,156,158 of the statement 142 such that the first semantic interpretation 122 is the same as the first semantic interpretation 122 of the first plurality of semantic interpretations 122,124,126,128 depicted in FIG. 2C. In this manner, the first semantic interpretation 122 may therefore be configured to compound over time such that the user may have an even better interaction experience with the AI model 70. Additionally, it will also be appreciated that the saving of the first semantic interpretation 122 may be performed independent of a conversation between the user and the AI model 70, such as a conversation including data beyond the first and second textual statements 112,142.

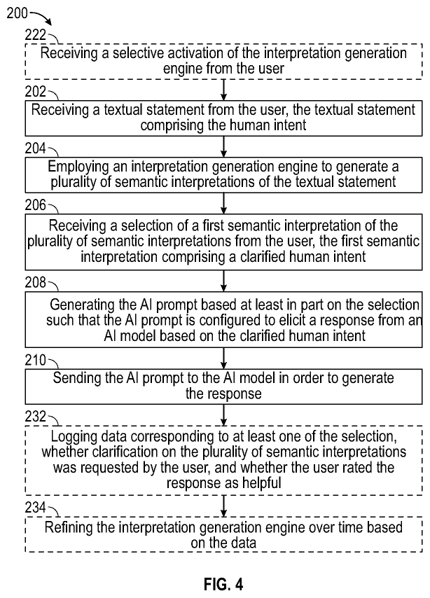

FIG. 4 shows an example computer-implemented method 200 for converting a human intent of a user into the AI prompt 132. The method 200 may be performed by the system 2, and in one example may include a first step 202 of receiving a textual statement 112,142 from the user, the textual statement 112,142 comprising the human intent; a second step 204 of employing an interpretation generation engine 20 to generate a plurality of semantic interpretations 122,124,126,128,154,156,158 of the textual statement; a third step 206 of receiving a selection of a first semantic interpretation 122 of the plurality of semantic interpretations 122,124,126,128,154,156,158 from the user, the first semantic interpretation 122 comprising a clarified human intent; a fourth step 208 of generating the AI prompt 132 based at least in part on the selection such that the AI prompt 132 is configured to elicit a response 142 from an AI model 70 based on the clarified human intent; and a fifth step 210 of sending the AI prompt 132 to the AI model in order to generate the response 142. The method 200 may also optionally include a step 222 of receiving a selective activation of the interpretation generation engine 20 from the user. Additionally, the method 200 may be performed without exposing to the user machine-optimized prompt representations (e.g., structured tokens, constraints, system instructions, embeddings, or control directives) that are generated by the system 2 for each of the semantic interpretations 122,124,126,128,154,156,158. In other words, the machine-optimized prompt representations of the semantic interpretations 122,124,126,128,154,156,158 may not be configured to be visible to the user via the user input device 10.

Continuing to refer to FIG. 4, the method 200 may optionally include a step 232 of logging data corresponding to at least one of the selection, whether clarification on the plurality of semantic interpretations 122,124,126,128,154,156,158 was requested by the user, and whether the user rated the response 142 as helpful; and a step 234 of refining the interpretation generation engine 20 over time based on the data. In one example, the step 232 may include logging data corresponding to each of the selection, whether clarification on the plurality of semantic interpretations 122,124,126,128,154,156,158 was requested by the user, and whether the user rated the response 142 as helpful. In this manner, the semantic interpretations 122,124,126,128,154,156,158 generated by the interpretation generation engine 20 may become more and more tailored to the human intent of the user as time goes on, thereby allowing the user to have desirable communication with the AI model 70 substantially devoid of hallucinations.

In one example, before the second step 204, the method 200 may further include steps that may be performed by the interpretation generation engine 20, including determining whether the textual statement 112,142 has a semantic clarity level above a predetermined threshold, and either sending the textual statement directly to the AI model 70 without first employing the interpretation generation engine 20 if the semantic clarity level is above the predetermined threshold, or employing the interpretation generation engine 20 to generate the plurality of semantic interpretations 122,124,126,128,154,156,158 if the semantic clarity level is below the predetermined threshold.

In other words, the system 2 and method 200 contemplate that if the user inputs a request that is already semantically clear, that request may be sent directly to the AI model 70. That is, the intent-clarification step of the disclosed method 200 may be conditionally invoked such that if a user's initial request is semantically clear, it may pass straight through with no interruption. Clarification options may only, in one example, be surfaced when reasonable semantic interpretations materially diverge (e.g., when the clarity level is below the predetermined threshold). In addition, users may optionally request clarification or toggle clarification behavior so that the system 2 does not slow users down unnecessarily.

The method 200 may further include saving the first semantic interpretation 122 after the selection from the user, receiving the second textual statement 142 from the user, and employing the interpretation generation engine 20 to generate the second plurality of semantic interpretations 122,154,156,158 of the second textual statement 142. In this instance, the second plurality of semantic interpretations 122,154,156,158 may include the first semantic interpretation 122 because the second textual statement 142 has a request signature matching a request signature of the first textual statement 112, and in order to allow the first semantic interpretation 122 to compound over time. These steps may include displaying the second plurality of semantic interpretations 122,154,156,158 to the user in a manner wherein the first semantic interpretation 122 is displayed as a first option. Thus, the user will be more likely to select the first semantic interpretation 122, thereby saving even more time while interacting with the AI model 70, and resulting in at least streamlined communication and reduced hallucinations.

Additionally, the system 2 may also include an optional “Final Prompt Recall” layer that saves the AI prompt 132 generated after the system 2 resolves ambiguity, and then later (e.g., without limitation, even months later, across new chat threads that have been newly initiated) can surface the AI prompt 132 as the first suggested option when a similar user request appears again. In one example, this may not require full conversation memory, but instead the system 2 may store only prompt-local memory surrounding the finalized AI prompt 132, for example with minimal metadata/signature needed to recognize similarity later. Accordingly, the goal may be to reduce repeated clarification cost and let proven prompts compound over time.

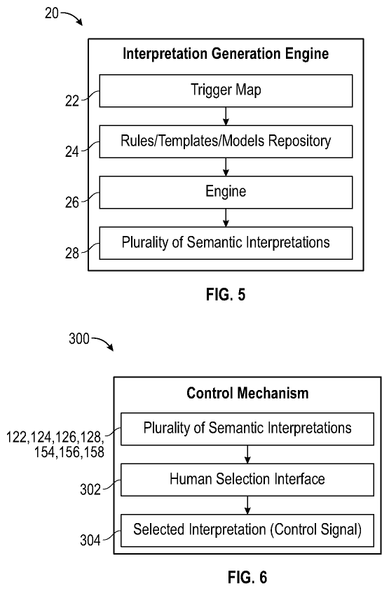

FIG. 5 illustrates a broad, non-limiting internal architecture of the interpretation generation engine 20. As shown, the interpretation generation engine 20 comprises a trigger map 22, a rules/templates/models repository 24, and an engine 26. The engine 26 may be configured to generate the plurality of semantic interpretations 122,124,126,128,154,156,158 responsive to a user request.

FIG. 6 illustrates a control mechanism 300 for the system 2 of FIG. 1. In one example, the control mechanism 300 corresponds to human confirmation. As shown, one of the semantic interpretations 122,124,126,128,154,156,158 may be sent to a human selection interface 302 of the system 2, which may in turn generate a selected interpretation 304. Accordingly, the system 2 may be conditionally invoked such that generation of the interpretations may be skipped when an intent confidence is high. Accordingly, human confirmation may function as the control mechanism 300, prompt recall may be provided for similar future inputs, and the separation between human-facing language and machine-facing prompts may be streamlined.

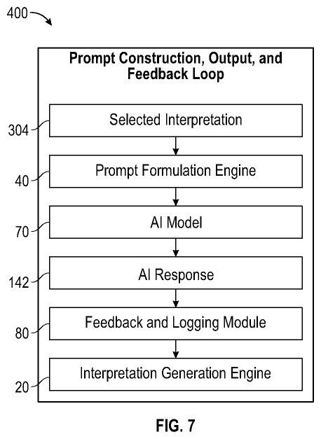

FIG. 7 shows an optional feedback loop 400 in which user selections, post-response clarification requests, and/or helpfulness signals are logged and used to refine interpretations, mappings, and wording over time. As shown in FIG. 7, the selected interpretation 304 may be sent to the prompt formulation engine 40, which may be sent to the AI model 70, which may generate the response 142, which may be sent to the feedback and logging module 80, which in turn may be sent to the interpretation generation engine 20 for refined generation of future semantic interpretations.

Accordingly, the disclosed system 2 is not simply an AI assistant that rewrites prompts, but instead is a structured interaction loop wherein users express intent in plain language, the system 2 reflects back multiple semantic interpretations 122,124,126,128,154,156,158, the user consciously selects one, and the system 2 then generates a specific, optimized AI prompt 132 based on that selection. In other words, the system 2 does not just rewrite silently. Instead, the system 2 uses the user's selection among structured options as a signal of intent, and then translates that into an internal machine-friendly prompt. The system 2 is thus designed to be a universal front-end layer that can be embedded into many AI models (e.g., without limitation, consumer, enterprise, etc.) as a common accessibility and accuracy tool.

In terms of data flow within the system 2, the user input device 10 may receive raw textual input (e.g., natural language) from the user. The textual statement 112 may thus be unstructured data containing human intent. The textual statement 112 may then be passed to the interpretation generation engine 20, which may in turn parse the textual statement 112 to extract data corresponding to action verbs (e.g., analyze, summarize, compare), objects (what the action applies to), constraints (timeframe, scope, audience, format), and decision indicators (instruction vs. exploration vs. execution). The interpretation generation engine 20 may map these extracted features against stored semantic patterns, intent templates, prior user selections (if any exist), confidence thresholds, and probabilistic scoring models. The interpretation generation engine 20 may also generate the plurality of semantic interpretations 122,124,126,128, each representing a distinct clarified version of the original intent. Each of the semantic interpretations 122,124,126,128 may be associated with an internal machine-optimized prompt representation (structured tokens, constraints, system instructions) that is not shown to the user.

As stated above, the semantic interpretations 122,124,126,128 may be passed to the user selection module 30, which may present human-readable versions of the interpretations to the user via the user input device 10, wherein the machine-optimized representations remain hidden. Once the user selects one of the semantic interpretations 122,124,126,128, the user selection module 30 passes the selection (and its associated machine-optimized representation) to the prompt formulation engine 40. The prompt formulation engine 40 then generates the final AI prompt 132 by incorporating the clarified intent from the selected interpretation, adding trigger words designed to improve accuracy, structuring the prompt with appropriate context, constraints, and directives, and combining elements from the original textual statement 112 with the clarified interpretation. The prompt formulation engine 40 passes the finalized AI prompt 132 to the AI engine interface 50, which may send the AI prompt 132 to the model 70, which may in turn generate a response. Accordingly, the response from the model 70 may be received by the response handling module 60, which may format and deliver the response to the user via the user input device 10. The system may optionally store the selected interpretation (for interpretation compounding), the finalized AI prompt 132 (for prompt compounding/Final Prompt Recall), and metadata including the original textual statement's request signature, timestamp, and user feedback signals.

In one example, the interpretation generation engine (20) improves through a feedback loop. More specifically, every time a user selects an interpretation, the system 2 logs which interpretation was selected, the original textual statement 112, and the request signature of that statement. If the user requests clarification on the presented interpretations before selecting, that signal is logged, indicating the initial interpretations were insufficient. If the user rates the final response as helpful or unhelpful, that signal is logged and associated with the selected interpretation. Over time, this logged data is used to adjust probabilistic scoring models so that interpretations similar to frequently-selected ones score higher, update intent templates to better match observed user selection patterns, modify confidence thresholds based on clarification request frequency, and weight certain semantic patterns higher based on helpfulness signals. Moreover, when a stored interpretation resurfaces, and the user re-selects it, that reinforces the interpretation's relevance for that request signature, strengthening the mapping over time.

It will also be appreciated that the prompt formulation engine 40 may improve indirectly. As the interpretation generation engine 20 gets better at surfacing relevant interpretations, the prompt formulation engine 40 receives higher-quality clarified intent as input, resulting in better prompts. Additionally, final prompt recall, discussed above, may allow proven prompts to be stored and reused, bypassing regeneration entirely. Additionally, when interpretation compounding is active, the user selection module 30 may display previously-selected interpretations as the first option, reducing user effort. Furthermore, the response handling module 60 may improve indirectly through the feedback loop. For instance, if helpfulness signals indicate poor responses, that data may flow back to refine the interpretation generation engine 20, which may improve future inputs to the response handling module 60.

In terms of matching request signatures (e.g., between the first and second textual statements 112,142), a request signature may be a structured representation of the key semantic features of a given one of the textual statements 112,142. The request signatures may not be the raw text themselves, but abstracted fingerprints that captures action type (e.g., the primary verb or intent category such as explain, compare, summarize, troubleshoot), object class (e.g., the category of thing the action applies to such as device, concept, process, data), constraint dimensions (e.g., timeframe, scope, audience, format, or other modifiers present in the request), and domain indicators (e.g., keywords or context that indicate subject matter such as medical, financial, technical). In this manner, when a new textual statement arrives, the interpretation generation engine 20 may extract the request signature from the new textual statement (e.g., the textual statement 142) and compare it against stored request signatures from prior interactions. The comparison may be performed as a similarity calculation across the signature dimensions: action type match (exact or categorical similarity), object class match (exact or categorical similarity), constraint dimension overlap (partial matching allowed), and domain indicator overlap. Furthermore, thresholds may be employed during the comparison. For instance, a similarity threshold may determine whether two request signatures are matching. If the similarity score exceeds the threshold, the system 2 may treat them as matching and resurface the stored interpretation or prompt. If the similarity score is below the threshold, the system 2 may generate fresh interpretations without relying on stored selections. The threshold may be configurable and may be adjusted over time based on user feedback. For example, if users frequently reject resurfaced interpretations, the threshold may be raised to require closer matches.

As employed herein, the term “clarified human intent” does not mean the system 2 infers what the user meant. Instead, the system 2 may present explicit alternatives and let the human confirm. For instance, the interpretation generation engine 20 may receive the raw textual statement 112, analyze the textual statement 112 and identify dimensions where the meaning is ambiguous, meaning where the statement could reasonably map to more than one specific intent. Examples of ambiguity dimensions may include scope ambiguity (e.g., “Summarize sales” could mean all sales, by region, or by product), objective ambiguity (e.g., “Help with my presentation” could mean create slides, review content, or suggest structure), and format ambiguity (e.g., “Explain X” could mean step-by-step, high-level overview, for an expert, or for a beginner).

For each identified ambiguity dimension, the interpretation generation engine 20 may generate candidate resolutions, combine these into the plurality of semantic interpretations 122,124,126,128, each representing a complete, unambiguous version of the original intent. Each interpretation may explicitly specify what was ambiguous. For example: “Summarize sales by region for Q3,” “Summarize sales by product for the full year,” or “Summarize total sales with year-over-year comparison.” The user selection module 30 may present these interpretations to the user, the user may select the one that matches their actual intent, and this selection may be the clarification in that the user has explicitly confirmed which interpretation is correct.

Moreover, the selected interpretation (now clarified human intent) may be passed to the prompt formulation engine 40, the prompt formulation engine 40 may generate the AI prompt 132 based on this clarified, unambiguous intent. In other words, the system 2 does not infer intent silently, but instead surfaces possible interpretations and requires human confirmation. Clarified human intent in this regard may equal the interpretation the user explicitly selected. The role of the interpretation generation engine 20 may be to identify ambiguity in the textual statement 112 and generate candidate resolutions (the plurality of semantic interpretations 122,124,126,128), not to guess which interpretation the user intended. The human confirms intent through selection.

In one example, the interpretation generation engine 20 may be an engine that learns over time. For instance, users may submit textual statements (e.g., the statements 112,142) →the interpretation generation engine 20 may generate the interpretations 122,124,126,128,154,156,158; the user may select one interpretation 122 →the selection may be logged with the original textual statement 112, the request signature, the selected interpretation, and timestamp; the AI model 70 may generate a response →the user may provide feedback (helpful or not helpful, or requests clarification). Accordingly, feedback may be logged and associated with the selected interpretation, and periodically or continuously, the interpretation generation engine 20 may refine semantic pattern mappings (patterns that lead to frequently-selected interpretations are weighted higher), intent templates (templates are updated to better match observed selection behavior), probabilistic scoring models (models are adjusted so higher-scoring interpretations align with user preferences), and confidence thresholds (if users frequently request clarification, thresholds may be lowered to surface more options; if users consistently select the first option, thresholds may be raised).

In terms of secondary learning (e.g., interpretation compounding) in the system 2, the user may select a first interpretation 122 for the textual statement 112, the system 2 may store the mapping of the request signature to the interpretation, and later, the user may submit the second textual statement 142 with a matching request signature. Thus, the system 2 may retrieve the first interpretation 122 and include it in the new plurality of interpretations 122,154,156,158 as the first option. If the user re-selects the first interpretation 122, the association may be reinforced. If the user selects a different interpretation, the system 2 may update the stored mapping or retain both as options.

In terms of tertiary learning in the system 2, the user may confirm an interpretation →the prompt formulation engine 40 may generate the AI prompt 132, and the system 2 may store the mapping of the request signature to the finalized AI prompt 132 with minimal metadata. Later, the user may submit a similar request, and the system 2 may retrieve the AI prompt 132 and surface it directly, skipping interpretation generation. In turn, if the user accepts, the AI prompt 132 may be reinforced as proven. If the user rejects or modifies, the system 2 may update the stored AI prompt 132 or fall back to interpretation generation.

In one example, the prompt formulation engine 40 may be provided with improved inputs as the interpretation generation engine 20 learns. Moreover, the user selection module 30 may be provided with a presentation order that is influenced by compounding (previously-selected interpretations may surface first). Furthermore, the response handling module 60 may serve as a source of helpfulness signals that feed back to the interpretation generation engine 20.

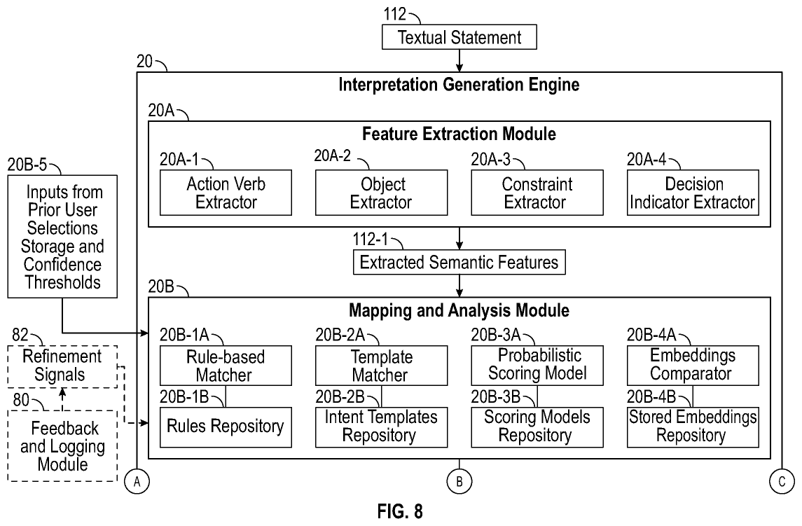

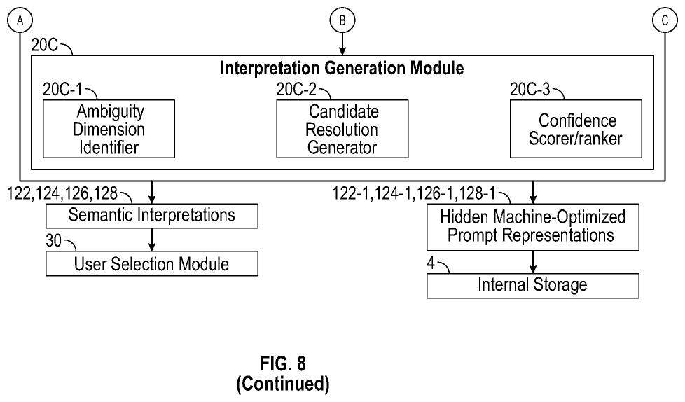

FIG. 8 illustrates a hybrid architecture of the interpretation generation engine 20, in accordance with one non-limiting embodiment of the disclosed concept. As shown in FIG. 8, the interpretation generation engine 20 implements a multi-stage processing pipeline configured to transform unstructured raw textual input (e.g., the textual statement 112) into a plurality of distinct semantic interpretations 122,124,126,128 while maintaining separate human-facing and machine-optimized representations. The architecture integrates rule-based, template-based, probabilistic, and embeddings-driven techniques to support accurate ambiguity resolution, confidence scoring, and continuous refinement through user feedback.

In the input stage, raw textual input (e.g., the textual statement 112) (comprising unstructured natural language expressing human intent) enters the engine 20. As shown, stage one includes a feature extraction module 20A of the engine 20 that includes subcomponents such as an action verb extractor 20A-1, an object extractor 20A-2, a constraint extractor 20A-3, and a decision indicator extractor 20A-4. These subcomponents 20A-1,20A-2,20A-3,20A-4 parse the textual statement 112 to derive extracted semantic features 112-1, which is an output for downstream processing.

Stage two includes a mapping and analysis module 20B. This module 20B operates along parallel paths that leverage stored data repositories, including: a rule-based matcher 20B-1A connected to a rules repository 20B-1B, a template matcher 20B-2A connected to an intent templates repository 20B-2B, a probabilistic scoring model 20B-3A connected to a scoring models repository 20B-3B, and an embeddings comparator 20B-4A connected to a stored embeddings repository 20B-4B. The mapping and analysis module 20B further incorporates inputs from prior user selections storage and confidence thresholds 20B-5 to map and analyze the extracted semantic features 112-1 against stored semantic patterns, intent templates, and probabilistic models. This stage produces candidate mappings and ranked analyses that resolve dimensions of ambiguity in the input.

Stage three includes an interpretation generation module 20C that includes an ambiguity dimension identifier 20C-1, a candidate resolution generator 20C-2, and a confidence scorer/ranker 20C-3. This interpretation generation module 20C synthesizes the outputs from the mapping and analysis module 20B to generate the plurality of distinct semantic interpretations 122,124,126,128. The human-readable semantic interpretations 122,124,126,128 flow outward to the user selection module 30 for presentation to the user. Concurrently, associated hidden machine-optimized prompt representations 122-1,124-1,126-1,128-1 (comprising structured tokens, system instructions, control directives, and the like) may be directed to an internal storage 4 of the system 2, and may remain not exposed to the user.

Additionally, a feedback path, shown as a dashed line, may connect the feedback and logging module 80 back into stage two (e.g., the mapping and analysis module 20B). This path may carry refinement signals 82 derived from logged user selections, clarification requests, response helpfulness ratings, and other interaction data. Over time, these signals 82 may dynamically refine the probabilistic scoring models, intent templates, semantic patterns, confidence thresholds, and other components of the engine 20, enabling personalization and improved performance for subsequent inputs.

Accordingly, the disclosed hybrid architecture may allow the interpretation generation engine 20 to balance precision (via rules and templates), adaptability (via embeddings and probabilistic models), and learning (via the feedback loop), all while preserving a clean, user-friendly interface that hides machine-optimized representations 122-1,124-1,126-1,128-1. Additional embodiments and variations of this architecture are contemplated within the scope of the disclosed concept.

In various embodiments, the interpretation generation engine 20 may implement a hybrid architecture that combines multiple complementary techniques. For example, the engine 20 may extract semantic features and apply rule-based and template matching for high-precision interpretations, probabilistic scoring models and confidence thresholds for ranking, and machine learning models or embeddings-based similarity comparisons for handling novel intents. In some implementations, the engine 20 may generate vector embeddings of the textual statement 112 and compare them against stored embeddings using similarity metrics. This hybrid approach enables the system to dynamically balance accuracy, computational efficiency, and personalization.

The interpretation generation engine 20 may also further support advanced uncertainty handling. When the semantic clarity level of a textual statement 112 falls within an intermediate range, the system 2 may surface a variable number of semantic interpretations (e.g., 3 to 6) ranked by confidence score. In high-confidence cases, the system 2 may automatically apply the top interpretation while still offering the user an option to review alternatives. In low-confidence cases, the system 2 may prompt the user with clarifying questions in addition to the semantic interpretation options.

The request signature used for interpretation compounding and Final Prompt Recall may each comprise a multi-dimensional feature vector that may include semantic embeddings, action type classifications, object class hierarchies, constraint parameters, domain indicators, and user-specific context vectors. Similarity between request signatures may be calculated using a weighted combination of embedding similarity (e.g., cosine similarity), categorical matching, and edit distance metrics. Thresholds for determining a match may be dynamically adjustable based on observed user acceptance rates of resurfaced interpretations. This enables robust long-term memory of proven interpretations and prompts across different conversation threads and time periods (e.g., days, weeks, or months later) while minimizing false positives.

The system 2 may also be designed to be fully model-agnostic and extensible. The prompt formulation engine 40 may generate prompts optimized for different underlying AI models (e.g., the AI model 70) by incorporating model-specific trigger patterns, output formatting constraints, and tool-calling structures. The system 2 may further operate in a hybrid edge-cloud configuration, performing lightweight interpretation generation on-device for privacy and latency-sensitive scenarios while leveraging cloud resources for more computationally intensive model updates.

It will also be appreciated that the system 2 may be implemented on one or more computing devices. In one embodiment, the system 2 comprises one or more processors and a memory storing instructions that, when executed by the one or more processors, cause the system 2 to implement the various components and perform the functions described herein. The one or more processors may include general-purpose processors, specialized processors (e.g., graphics processing units), or any combination thereof. The memory may include volatile memory (e.g., RAM), non-volatile memory (e.g., flash memory, hard disk drives, solid-state drives), or any combination thereof. The memory stores executable instructions, data structures (including semantic patterns, scoring models, intent templates, request signatures, and user preference profiles), and other information necessary for operation of the system.

In various embodiments, portions of the system 2 may be distributed across multiple computing devices. For example, the user input device 10 may be a client device (such as a smartphone, tablet, or personal computer) that communicates with one or more remote servers that implement the interpretation generation engine 20, the prompt formulation engine 40, the feedback and logging module 80, and storage components. Alternatively, some or all of the interpretation generation 20 and the prompt formulation functions may be performed locally on the user input device 10 for improved latency and privacy. The system 2 may also utilize cloud computing resources for computationally intensive tasks such as machine learning model training or large-scale similarity comparisons.

The memory and processors may be configured to enable the technical improvements described herein, including the real-time analysis of unstructured natural language, generation of semantic interpretations with associated hidden machine-optimized prompt representations, user-driven intent clarification, and continuous refinement of the interpretation generation engine through feedback. This hardware and software architecture allows the system 2 to function as an effective intent-translation layer between human users and AI models.

It will therefore be appreciated that the system 2 comprises one or more processors and a memory storing instructions that, when executed by the one or more processors, cause the system 2 to implement the components described herein. In particular, the system 2 includes a user input device 10 configured to receive unstructured natural language textual statements 112 expressing human intent; an interpretation generation engine 20 configured to parse such statements to extract semantic features 112-1, map those features 112-1 against stored semantic data, and generate a plurality of distinct semantic interpretations 122,124,126,128 each having an associated hidden machine-optimized prompt representation 122-1,124-1,126-1,128-1; a user selection module 30 that receives explicit user confirmation of a clarified intent from the presented interpretations; a prompt formulation engine 40 that generates an optimized AI prompt 132 based on the selected interpretation 122 and its hidden representation 122-1; and an AI engine interface 50 that delivers the optimized prompt 132 to an AI model 70. This architecture enables the system 2 to function as an effective intent-translation layer between users and AI models, as further detailed throughout the specification.

In one example, the interpretation generation engine 20 implements the hybrid multi-stage processing pipeline described herein through the following exemplary algorithmic steps and structures. A person of ordinary skill in the art in the fields of natural language processing and machine learning, having access to standard libraries and frameworks (e.g., spaCy, Hugging Face Transformers, scikit-learn, and vector databases such as FAISS), would be able to implement the engine 20 without undue experimentation.

As shown in FIG. 8, the engine 20 transforms unstructured raw textual input (e.g., the textual statement 112) into a plurality of distinct semantic interpretations 122,124,126,128 while maintaining separate human-facing and machine-optimized representations 122-1,124-1,126-1,128-1. In the input stage, raw textual input enters the engine 20. Stage one includes a feature extraction module 20A comprising an action verb extractor 20A-1, an object extractor 20A-2, a constraint extractor 20A-3, and a decision indicator extractor 20A-4. These subcomponents, alone or in any combination, parse the textual statement 112 using natural language processing techniques such as part-of-speech tagging, dependency parsing, and named-entity recognition to derive extracted semantic features 112-1.

Stage two includes a mapping and analysis module 20B that processes the extracted semantic features 112-1 along parallel paths using rule-based, template-based, probabilistic, and embeddings-based techniques against stored data repositories. These paths include: (1) a rule-based matcher 20B-1A applying deterministic pattern rules against a rules repository 20B-1B; (2) a template matcher 20B-2A performing slot-filling against an intent templates repository 20B-2B; (3) a probabilistic scoring model 20B-3A (e.g., logistic regression, XGBoost, or a small feed-forward neural network) trained on historical user statements paired with selected interpretations and helpfulness ratings; and (4) an embeddings comparator 20B-4A that generates vector representations using a pre-trained sentence embedding model (such as all-MiniLM-L6-v2 or a fine-tuned Sentence-BERT model) and compares them via cosine similarity against stored embeddings. The module 20B may also incorporate prior user selections and confidence thresholds 20B-5.

Stage three includes an interpretation generation module 20C comprising an ambiguity dimension identifier 20C-1, a candidate resolution generator 20C-2, and a confidence scorer/ranker 20C-3. This module 20C synthesizes the outputs from stage two to generate the plurality of distinct semantic interpretations 122,124,126,128. Each interpretation 122,124,126,128 includes both a human-readable form (presented via the user selection module 30) and an associated hidden machine-optimized prompt representation 122-1,124-1,126-1,128-1 stored internally. For example, a human-readable interpretation might state “Summarize sales by region for Q3,” while the corresponding hidden representation comprises a structured payload such as: {role: “expert analyst”, task: “summarize”, object: “sales_data”, constraints: {group_by: “region”, timeframe: “Q3”}, output_format: “structured_table_with_totals”, anti_hallucination_directives: “cite sources if available, avoid speculation”} together with system instructions and control directives. The confidence score may be computed as a weighted aggregation of the four parallel scorers, with ranking performed to promote diversity among the presented interpretations.

The engine 20 further supports interpretation compounding and Final Prompt Recall through request signatures. A request signature is a multi-dimensional structured fingerprint comprising at least one of an action type, object class, constraint dimensions, and domain indicators, optionally augmented with semantic embeddings. Similarity between signatures may be computed using a weighted combination such as: Similarity=w₁·action_match+w₂·object_match+w₃·Jaccard(constraint_dims)+w₄·cosine(embedding), where weights may be learned or tuned based on user feedback. If the similarity score satisfies a predetermined (and dynamically adjustable) threshold, previously selected interpretations and/or finalized AI prompts are resurfaced. A feedback and logging module 80 may continuously refine the engine 20 by updating probabilistic models, intent templates, semantic patterns, and confidence thresholds based on logged user data.

To further illustrate operation of the interpretation generation engine 20, two additional end-to-end examples are provided. In a first example, the user enters the vague textual statement “My phone is acting weird.” Stage one (feature extraction) identifies the action verb “acting,” object “phone,” and constraint “weird” (indicating a troubleshooting intent with low specificity). Stage two maps these features in parallel: the rule-based matcher 20B-1A identifies a troubleshooting pattern, the template matcher 20B-2A matches against stored device-support templates, the probabilistic model 20B-3A assigns high probability to hardware/software diagnosis based on prior selections, and the embeddings comparator 20B-4A finds similarity to previous “device issue” vectors. Stage three identifies ambiguity dimensions (e.g., hardware vs. software issue, symptom severity, desired output format) and generates distinct interpretations such as: (1) “Diagnose and fix common software glitches on my smartphone,” and (2) “Troubleshoot hardware problems causing unusual behavior on my mobile device.” Each interpretation 122,124,126,128 carries a hidden machine-optimized representation 122-1,124-1,126-1,128-1, for instance: {role: “technical support specialist”, task: “diagnose”, object: “smartphone”, constraints: {focus: “software_glitches”, steps: “step_by_step”, anti_hallucination: “base on common issues only”}}. After the user selects one, the prompt formulation engine 40 generates an optimized AI prompt 132 incorporating the clarified intent and hidden structure, which is sent to the AI model 70.

In a second example, the user inputs “Help with my presentation.” Stage one extracts action “help,” object “presentation,” and decision indicator (open-ended assistance). Stage two combines template matching against presentation-related intents with embeddings similarity to prior “content creation” requests and probabilistic scoring favoring structure over full creation. Stage three resolves objective and format ambiguities to produce interpretations such as: (1) “Create a detailed outline and speaker notes for a 10-minute business presentation,” and (2) “Review and suggest improvements to existing presentation slides for clarity and engagement.” The corresponding hidden representations 122-1,124-1,126-1,128-1 include structured fields for output format, audience level, and constraints (e.g., “limit to bullet points and key visuals, avoid generic advice”). These examples demonstrate how the multi-stage pipeline systematically resolves ambiguity in unstructured natural language to produce both user-selectable interpretations and internally optimized prompt structures.

It will be appreciated that the specific techniques and models described above are exemplary. Equivalent implementations using other natural language processing libraries, different machine learning architectures (e.g., other transformer-based models), or alternative similarity metrics are contemplated within the scope of the disclosed concept and would be readily apparent to a person of ordinary skill in the art. It will also be understood that the abovementioned arrangements of apparatus are merely illustrative of applications of the principles of this invention and many other embodiments and modifications may be made without departing from the spirit and scope of the invention as defined in the claims.

What is claimed is:

1. A system for converting a human intent of a user into an artificial intelligence (AI) prompt, the system comprising:
one or more processors; and
a memory storing instructions that, when executed by the one or more processors, cause the system to implement:
a user input device configured to receive a textual statement from the user, the textual statement comprising unstructured natural language expressing the human intent;
an interpretation generation engine configured to:
receive the textual statement,
parse the textual statement to extract semantic features from the unstructured natural language,
analyze the textual statement by mapping the semantic features against stored semantic data, and
generate a plurality of distinct semantic interpretations of the textual statement based on the analysis, wherein each semantic interpretation resolves one or more dimensions of ambiguity in the textual statement and has an associated hidden machine-optimized prompt representation that is not exposed to the user;
a user selection module configured to receive, from the user via the user input device, a selection of a first semantic interpretation of the plurality of semantic interpretations, the first semantic interpretation comprising a clarified human intent explicitly confirmed by the user;
a prompt formulation engine configured to generate the AI prompt based at least in part on the selected first semantic interpretation and its associated machine-optimized prompt representation such that the AI prompt is structured to elicit an improved response from an AI model; and
an AI engine interface configured to send the AI prompt to the AI model.

2. The system of claim 1, wherein the one or more dimensions of ambiguity comprise one or more of scope ambiguity, objective ambiguity, and format ambiguity.

3. The system of claim 1, wherein the parsing of the textual statement is performed in order to extract at least one of action verbs, objects, constraints, and decision indicators from the textual statement.

4. The system of claim 1, wherein the interpretation generation engine implements a hybrid multi-stage architecture comprising: a feature extraction stage configured to parse the textual statement and derive the semantic features; a mapping and analysis stage configured to process the extracted semantic features using parallel rule-based, template-based, probabilistic, and embeddings-based techniques against stored data repositories; and an interpretation generation stage configured to identify ambiguity dimensions, generate candidate resolutions, and rank the plurality of semantic interpretations using confidence scoring.

5. The system of claim 1, wherein the interpretation generation engine is further configured to analyze the textual statement by mapping the semantic features against one or more of stored intent template data, stored prior user selection data, and stored confidence threshold data.

6. The system of claim 1, wherein the hidden machine-optimized prompt representation comprises one or more of structured tokens, system instructions, and control directives.

7. The system of claim 1, wherein the interpretation generation engine is further configured to determine a semantic clarity level of the textual statement and to generate the plurality of semantic interpretations only when the semantic clarity level is below a predetermined threshold.

8. The system of claim 1, wherein the user input device is configured to provide selective activation of a prompt mode, and wherein the interpretation generation engine is invoked only when the prompt mode is activated.

9. The system of claim 1, further comprising a storage module configured to: save the first semantic interpretation in association with a request signature of the textual statement; and upon receiving a second textual statement having a request signature that satisfies a similarity threshold with the request signature of the first textual statement, cause the interpretation generation engine to include the saved first semantic interpretation in a new plurality of semantic interpretations.

10. The system of claim 9, wherein the storage module is further configured to save the generated AI prompt, and to surface the saved AI prompt as a suggested option for similar future textual statements.

11. The system of claim 1, further comprising a feedback and logging module configured to:
log data corresponding to the user selection, whether clarification on the plurality of semantic interpretations was requested, and whether the user rated the response from the AI model as helpful; and
dynamically refine the interpretation generation engine over time based on the logged data.

12. The system of claim 11, wherein the feedback and logging module is further configured to refine at least one of: probabilistic scoring models, intent templates, semantic patterns, or confidence thresholds of the interpretation generation engine based on logged user selections, clarification requests, and response helpfulness ratings.

13. The system of claim 1, further comprising a storage module configured to generate and store a request signature for the textual statement, and wherein the request signature is a structured fingerprint comprising at least an action type, an object class, constraint dimensions, and domain indicators.

14. The system of claim 13, wherein the textual statement is a first textual statement, wherein the request signature is a first request signature, wherein the interpretation generation engine is further configured to compare a second request signature of a second textual statement against the first request signature using a similarity calculation, and to include a previously selected semantic interpretation in a new plurality of semantic interpretations when the similarity calculation satisfies a predetermined similarity threshold.

15. The system of claim 14, wherein the similarity threshold is dynamically adjustable based on logged user acceptance rates of previously resurfaced interpretations.

16. The system of claim 13, wherein the textual statement is a first textual statement, wherein the request signature is a first request signature, and wherein the system is configured to save the generated AI prompt in association with the first request signature, and to surface the saved AI prompt as a suggested prompt for a second, later textual statement having a second request signature matching the first request signature.

17. The system of claim 1, wherein the clarified human intent comprises an explicit user confirmation of one of a plurality of candidate resolutions to ambiguity dimensions identified in the textual statement, rather than an inferred intent.

18. The system of claim 1, wherein the system maintains separate human-facing interpretations and machine-facing prompt representations, such that the machine-optimized prompt representations are never exposed to the user via the user input device.

19. A computer-implemented method for converting a human intent of a user into an artificial intelligence (AI) prompt, the method comprising:
receiving, by a user input device, a textual statement from the user, the textual statement comprising unstructured natural language expressing the human intent;
by an interpretation generation engine:
receiving the textual statement,
parsing the textual statement to extract semantic features from the unstructured natural language,
analyzing the textual statement by mapping the semantic features against stored semantic data, and
generating a plurality of distinct semantic interpretations of the textual statement based on the analysis, wherein each semantic interpretation resolves one or more dimensions of ambiguity in the textual statement and has an associated hidden machine-optimized prompt representation that is not exposed to the user;
receiving, by a user selection module from the user via the user input device, a selection of a first semantic interpretation of the plurality of semantic interpretations, the first semantic interpretation comprising a clarified human intent explicitly confirmed by the user;
generating, by a prompt formulation engine, the AI prompt based at least in part on the selected first semantic interpretation and its associated hidden machine-optimized prompt representation such that the AI prompt is structured to elicit an improved response from an AI model; and
sending, by an AI engine interface, the AI prompt to the AI model.

20. The computer-implemented method of claim 19, wherein the one or more dimensions of ambiguity comprise one or more of scope ambiguity, objective ambiguity, and format ambiguity.
